(19) United States
(12) Patent Application Publication
(10) Pub. No.: US 2023/0084096 A1
(43) Pub. Date: Mar. 16, 2023

(54) A METHOD AND AN APPARATUS FOR ESTIMATING AN APPEARANCE OF A FIRST TARGET

(71) Applicant: NEC Corporation, Minato-ku, Tokyo (JP)

(72) Inventors: Hui Lam ONG, Singapore (SG); Wei Jian PEH, Singapore (SG); Qinyu HUANG, Singapore (SG); Satoshi YAMAZAKI, Singapore (SG)

(73) Assignee: NEC Corporation, Minato-ku, Tokyo (JP)

(21) Appl. No.: 17/800,000

(22) PCT Filed: Feb. 26, 2021
(86) PCT No.: PCT/JP2021/007268

§ 371 Date: Aug. 16, 2022

(30) Foreign Application Priority Data
Mar. 23, 2020 (SG) 10202002677T

(51) Int. Cl. G06T 7/73; G06T 7/536

(52) U.S. Cl. CPC G06T 7/74; G06T 7/536

(57) ABSTRACT

Present disclosure provides a method and an apparatus (404) for estimating an appearance of a first target in a frame, the frame being one in which a second target appears and the first target does not appear. The method comprising: retrieving appearance data relating to the first target in at least two frames before and after the frame within a threshold period, the at least two frames being those in which the first target appears; identifying location information and time information of the first target in the at least two frames based on the retrieved appearance data; and estimating the appearance of the first target in the frame based on the identified location information and the time information.

### TECHNICAL FIELD

The present invention relates broadly, but not exclusively, to methods for estimating an appearance of a first target in a frame, the frame being one in which a second target appears and the first target does not appear.

### BACKGROUND ART

Face recognition technologies are getting more and more popular due to the increasing availability of open source algorithms and affordable hardware. With capability to identify a target, such as a subject or a person, through detecting the target's appearance from an image frame or a video footage, face recognition technologies are often used in video surveillance system for public safety solution such as real-time security monitoring and post incident investigation. For example, face recognition technologies can be used to detect co-appearance of two or more targets and determine the two or more targets to be in contact with and related to each other. These technologies offer one of the important features in post investigation, as they help in discovering potential connection between two or more detected targets which might lead to new direction of investigation.

As face recognition technologies rely mainly on the visibility of a target's appearance, to detect appearances and co-appearances, some co-appearance may not be identified when the appearance of one of the targets are not detected in some of the image or video frames, for example due to varying environmental or imaging conditions and obstructions of the target from a field of view of the image capturing device. Such limitation may affect the accuracy of the face recognition technologies in discovering potential connection between the targets. A need therefore exists to provide methods for estimating an appearance of a first target in a frame, the frame being one in which a second target appears and the first target does not appear. The method seeks to address one or more of the above problems.

Furthermore, other desirable features and characteristics will become apparent from the subsequent detailed description and the appended claims, taken in conjunction with the accompanying drawings and this background of the disclosure.

### SUMMARY OF INVENTION

### Solution to Problem

In a first aspect, there is provided a method for estimating an appearance of a first target in a frame, the frame being one in which a second target appears and the first target does not appear, comprising: retrieving appearance data relating to the first target in at least two frames before and after the frame within a threshold period, the at least two frames being those in which the first target appears; identifying location information and time information of the first target in the at least two frames based on the retrieved appearance data; and estimating the appearance of the first target in the frame based on the identified location information and the time information.

In a second aspect, there is provided an apparatus for estimating an appearance of a first target in a frame, the frame being one in which a second target appears and the first target does not appear, comprising a memory in communication with a processor, the memory storing a computer program recorded therein, the computer program being executable by the processor to cause the apparatus at least to: retrieve appearance data relating to the first target in at least two frames before and after the frame within a threshold period, the at least two frames being those in which the first target appears; identify location information and time information of the first target in the at least two frames based on the retrieved appearance data; and estimate the appearance of the first target in the frame based on the identified location information and the time information.

In a third aspect, there is provided a system for estimating an appearance of a first target in a frame, the frame being one in which a second target appears and the first target does not appear, comprising the apparatus in the second aspect and an image capturing device.

### Advantageous Effects of Invention

According to the present disclosure, it is possible to provide a method and an apparatus for estimating an appearance of a first target.

### BRIEF DESCRIPTION OF DRAWINGS

Embodiments of the invention will be better understood and readily apparent to one of ordinary skill in the art from the following written description, by way of example only, and in conjunction with the drawings, in which:

FIG. 1A depicts an example implementation of an image capturing device used for identifying an appearance of a first target and an appearance of a second target in a frame.

FIG. 1B depicts three frames captured by the image capturing device of FIG. 1A.

FIG. 2A depicts a flow diagram illustrating a convention process for detecting a logical appearance of a target based on a plurality of image frames.

FIG. 2B depicts a flow diagram illustrating a convention process for detecting co-appearance of two subjects and storing co-appearance data based on appearances of the two subjects in a frame.

FIG. 3A depicts a flow chart 300 illustrating a method for estimating an appearance of a first target in a frame, the frame being one in which a second target appears and the first target does not appear, according to an embodiment.

FIG. 3B depicts a flow diagram illustrating the method depicted in FIG. 3A based on a plurality of image frames according to an embodiment.

FIG. 4 depicts a block diagram illustrating a system 400 for estimating an appearance of a first target in a frame, the frame being one in which a second target appears and the first target does not appear, according to an embodiment.

FIG. 5 depicts a flow diagram illustrating a method for estimating an appearance of a first target in a frame based on a plurality of image frames according to an embodiment.

FIG. 6 depicts a flow diagram illustrating a process for identifying co-appearance of two targets according to an embodiment.

FIG. 7 depicts a flow diagram illustrating a process for determining a co-appearance in-contact confidence score based on an estimated distance between two targets according to an embodiment.

FIG. 8A shows process of how an estimated distance of two targets is determined from an image frame according to an embodiment.

FIG. 8B shows process of how an estimated distance of two targets is determined from an image frame according to an embodiment.

FIG. 8C shows process of how an estimated distance of two targets is determined from an image frame according to an embodiment.

FIG. 9A depicts a flow chart illustrating a process of estimating an appearance of a first target in a frame according to an embodiment.

FIG. 9B depicts a flow chart illustrating a process of estimating an appearance of a first target in a frame according to an embodiment.

FIG. 10 depicts a schematic diagram of a computer system suitable for use to implement method and system shown in FIG. 3A and FIG. 4 respectively.

### DESCRIPTION OF EMBODIMENTS

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “receiving”, “calculating”, “determining”, “updating”, “generating”, “initializing”, “outputting”, “receiving”, “retrieving”, “identifying”, “dispersing”, “authenticating” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

Various embodiments of the present invention relate to methods and apparatuses for estimating an appearance of a first target in a frame, the frame being one in which a second target appears and the first target does not appear.

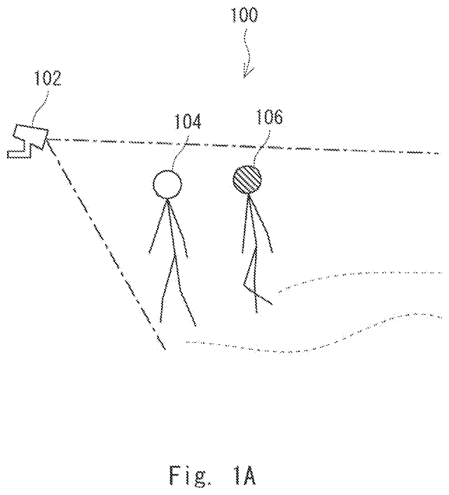

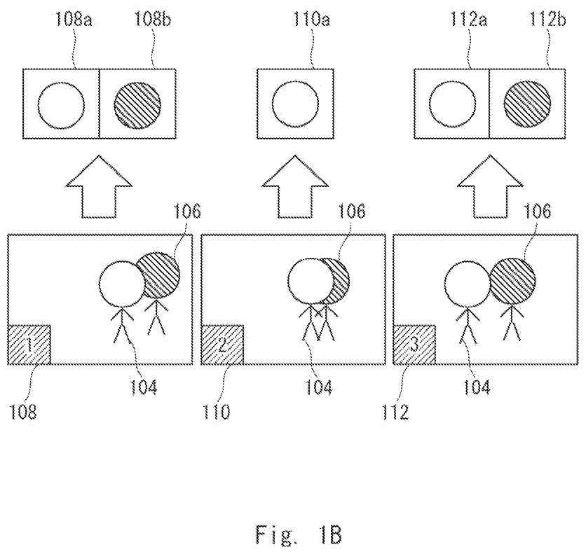

FIG. 1A depicts an example implementation 100 of an image capturing device 102 used for an appearance of a first target 104 and an appearance of a second target 106 in a frame. In this example, two targets, e.g. a first target 104 and a second target 106, are moving together from one point of a location to another point of the location. During which, the two targets 104, 106 may move into a field of view of image capturing device 102 (indicated as solid line projected from image capturing device 102), and their appearances are detected by image capturing device 102.

In various embodiments below, a co-appearance of two targets is detected when respective appearances of the two targets are detected in a same image frame. FIG. 1B depicts three example image frames 108, 110, 112 captured by the image capturing device 102 of FIG. 1A. In particular, three image frames 108, 110, 112 are captured at different time instances when two targets 104, 106 move into and appear within a field of view of image capturing device 102 as illustrated in FIG. 1A. In this example, a first, second and third image frame 108, 110, 112 may be consecutively captured by the image capturing device 102. Specifically, the image capturing device 102 may capture (or detect) a first image frame 108, followed by capturing a second image frame 110, and then a third image frame 112. In the first image frame 108, appearance data 108a, 108b corresponding to targets 104, 106 are detected respectively. As a result, a co-appearance of targets 104, 106 are detected in the first image frame 108. Subsequently, in the second image frame 110, appearance data 110a corresponding to second target 104 are detected. However, at this time instance when the second image frame 110 is captured, target 106 may be substantially blocked from the field of view of image capturing device 102. The partial appearance of the target 106 may not be sufficient for identifying target 106 based on the image frame 110. As a result, the target 106 could not be identified based on image frame 110. In the third image frame 112, both the targets 104, 106 appear clearly within the field of view of the image capturing device 102, and appearance data 112a, 112b corresponding to the targets 104, 106 are detected respectively. As a result, a co-appearance of the targets 104, 106 are detected in the image frame 112.

Conventionally, co-appearances of the targets 104, 106 are detected in the image frames 108 and 112 as both appearances of the targets 104, 106 are detected in the same image frame, respectively. However, the detection of co-appearance of the targets 104, 106 is missed in the image frame 110 due to the invisibility of one of the target's appearance, for example, caused by blockage or varying imaging conditions, and only the appearance of the target 104 is detected in the image frame 110. This may affect the calculation of co-appearance time or frequency between the targets 104, 106 and thus the determination of a likelihood of how the targets 104, 106 are related to each other or if there is any potential association or connection between the targets 104, 106. Moreover, the above problems will be aggravated when there is a plurality of targets in an image frame. Therefore, there is an object of present disclosure to substantially overcome the existing challenges as discussed above to estimate an appearance of a first target. In the following paragraphs, certain exemplifying embodiments are explained with reference to apparatus and method for estimating an appearance of a first target, the frame being one in which a second target appears and the first target does not appear.

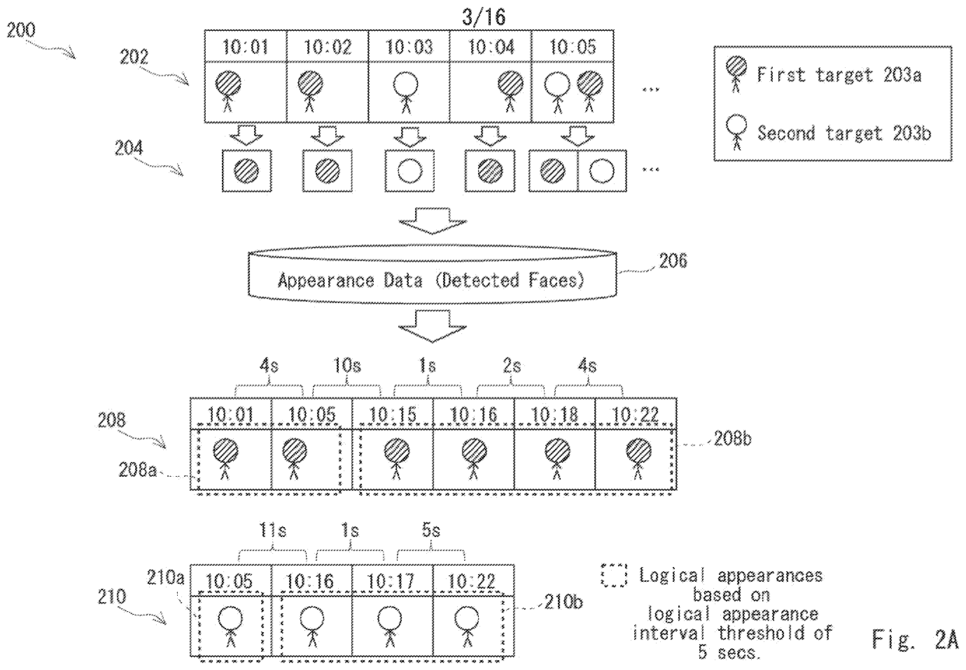

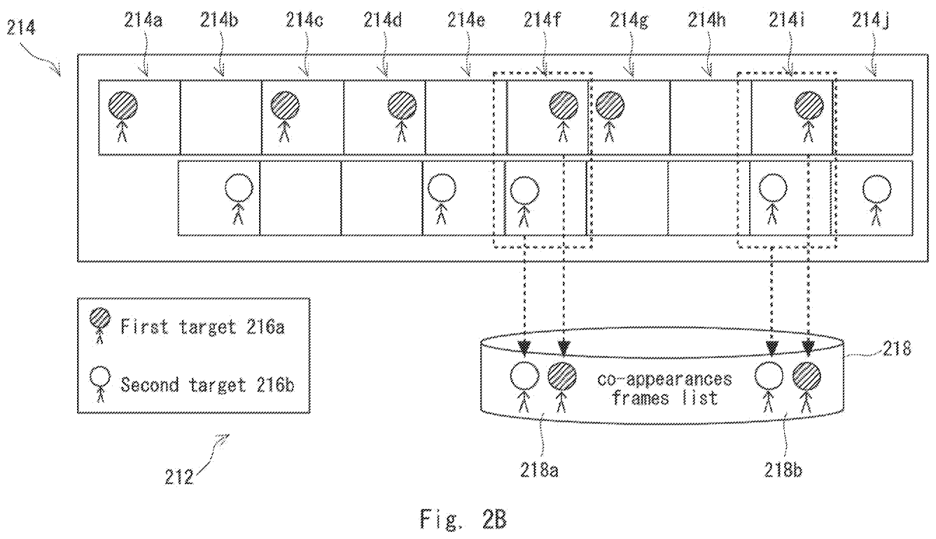

In various embodiments, an image capturing device may be configured to capture (or detect) at a pre-determined frames per second (or fps). For the sake of simplicity, an image frame captured (or detect) at an image capturing device at one frame per second is demonstrated. Further, for illustration purpose, a timestamp at which an image frame is captured may be indicated along with the image frame as shown in FIGS. 2A, 3B and 6. In particular, the minute and the second of the timestamp at which an image frame is captured is separated by a colon, so an image frame of 10:20 refers to an image frame captured (or detected) at 10:20 or at a timestamp of 10 minutes and 20 seconds.

FIG. 2A depicts a flow diagram 200 illustrating a process for detecting a logical appearance of a target based on a plurality of image frames according to an embodiment. Five image frames 202 captured within a time period of 10:01 and 10:05 are depicted. For each of the image frames captured, it is then determined based on appearance (e.g. facial features) if any target appears in the image frame. In particular, a first target 203a is detected in image frames of 10:01, 10:03, 10:04 and 10:05; whereas a second target 203b is in image frames of 10:03 and 10:05. The corresponding appearance data 204 of the first target 203a and the second target 203b in each image frame (e.g. facial information) are then stored and included in a list of appearance data 206.

In an embodiment, the frames in which the target appears are tabulated according to time information and location information for further processes. Tables 208, 210 of FIG. 2A depict how the frames in which the first target 203a and the second target 203b appear are tabulated respectively according to an embodiment. In particular, in tables 208, 210, the appearances of the first target 203a and the second target 203b are arranged respectively in a chronological order to determine a logical appearance.

In various embodiments, any two consecutive appearances of a target having an interval within a logical appearance interval threshold are grouped as a logical appearance; whereas two consecutive appearances of the target having an interval exceeds the logical appearance interval threshold are detected as two separate logical appearances of the target respectively. Specifically in a case shown in FIG. 2A where the logical appearance interval threshold is set to 5 seconds, two consecutive appearances of the first target 203a at 10:01 and 10:05 are detected within the threshold of 5 seconds, hence, the two consecutive appearances at 10:01 and 10:05 are grouped as a logical appearance as indicated in box 208a. On the other hand, two consecutive appearances of the first target 203a at 10:05 and 10:15 have an interval exceeds the logical appearance interval threshold, hence, the two appearances at 10:05 and 10:15 relates to two separate logical appearances as shown with two boxes 208a, 208b respectively in FIG. 2A. Similarly, four consecutive appearances of the first targets 203a at 10:15, 10:16, 10:18 and 10:22 relate to a single logical appearance as indicated in box 208b as every two consecutive appearances of the four consecutive appearances of the first targets at 10:15, 10:16, 10:18 and 10:22 are detected within the logical appearance interval threshold.

Similarly, appearances of the second target 203b at 10:05, 10:16, 10:17 and 10:22 may refer to two separate logical appearances, one being the appearance at 10:05 and other being the appearances at 10:16, 10:17 and 10:22, as illustrated in boxes 210a, 210b respectively, based on the same logical appearance detection processes and criteria.

FIG. 2B depicts a flow diagram 212 illustrating a convention process for detecting co-appearance of two targets and storing co-appearance data based on appearances of the two targets in an image frame. In an embodiment, image frames relating to two or more targets within a time period are retrieved and tabulated according to time information and location information to detect co-appearance of two or more targets. For example, image frames 214a to 214j in which appearances of a first target 216a and a second target 216b within a time period are retrieved and tabulated in a chronological order in table 214. In particular, it is detected that the first target 216a appears in image frames 214a, 214c, 214d, 214f, 214g, 214i whereas the second target 216b appears in image frames, 214b, 214e, 214f, 214i and 214j. Conventionally, based on table 214, it can be identified that both the first target 216a and the second target 216b appear in image frames 214f, 214i. Correspondingly, two co-appearances of the first target 216a and the second target 216b in the image frames 214f, 214i are detected.

Each image frame like 214f, 214i in which a co-appearance is detected may be stored in a list, such as co-appearance frame list 218, such that respective co-appearance data like 218a and 218b relating to each co-appearances of the first target 216a and the second target 216b may be retrieved for further analysis. The co-appearance data may comprise location information, time information and frame information in which the co-appearance is detected.

However, as mentioned earlier, such conventional co-appearance detection system relies on visibility and detection of target's appearance. As a result, some of the co-appearance detection may be missed due to the invisibility of a target's appearance. For example, based on table 214, it is noted that the first target 216a appears in image frames before and after the image frame 214b, e.g. image frames 214a and 214c, but does not appear in the image frame 214b. The absence of an appearance of the first target 216a in the image frame 214b may be caused by partial obstruction on the first target 216a from the field of view of the image capturing device at a time when the image frame 214b is captured (or detected). As a result, the conventional co-appearance detection system may not be able to detect a co-appearance of the first target 216a and the second target 216b in the image frame 214b or utilize such co-appearance detection in determining a potential connection and a likelihood of how the first and the second targets may be related to each other.

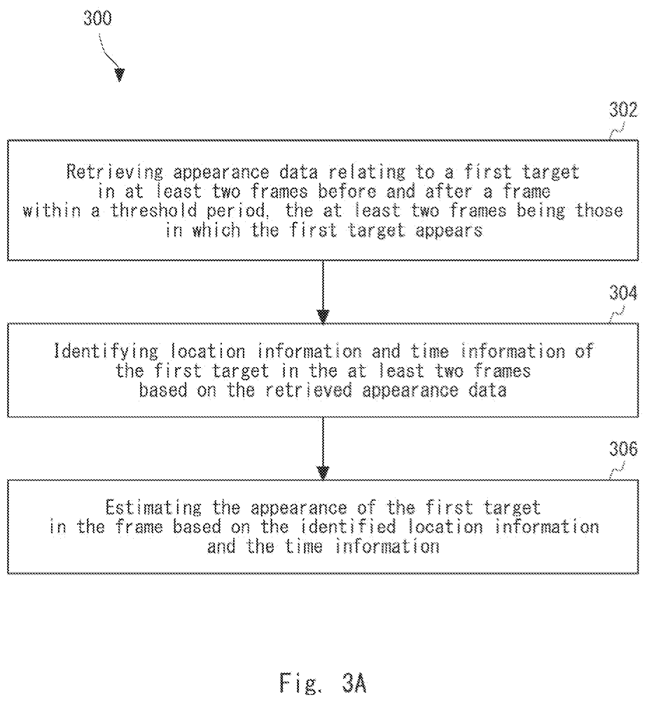

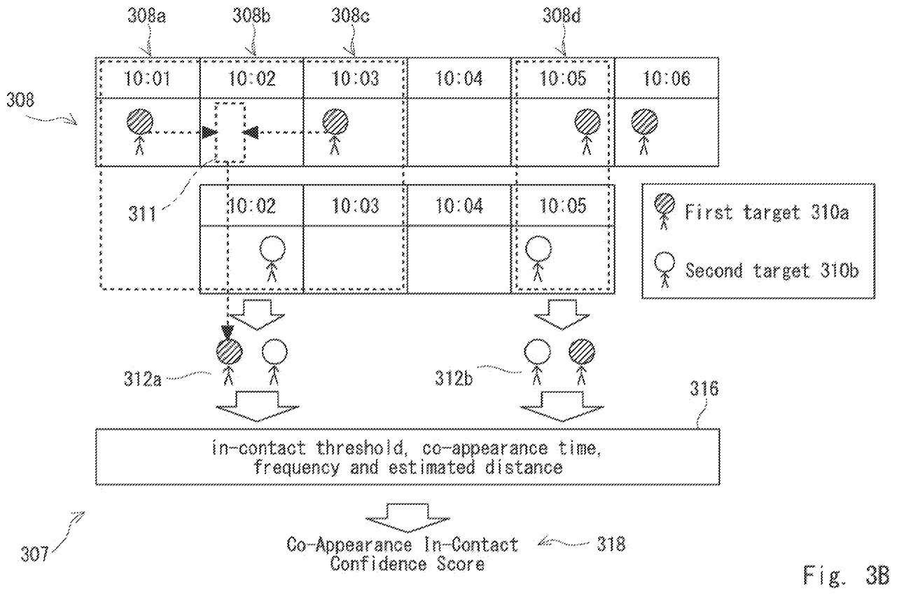

According to various embodiments of the present disclosure, the term “frame” may be used interchangeably with the term “image frame”. FIG. 3A depicts a flow chart 300 illustrating a method for estimating an appearance of a first target in a frame, the frame being one in which a second target appears and the first target does not appear, according to an embodiment. In step 302, the method may comprise a step of retrieving appearance data relating to a first target in at least two frames before and after a frame within a threshold period, the at least two frames being those in which the first target appears. Subsequently, in step 304, the method may comprise a step of identifying location information and time information of the first target in the at least two frames based on the retrieved appearance data. In step 306, the method may comprise a step of estimating the appearance of the first target in the frame based on the identified location information and the time information.

FIG. 3B depicts a flow diagram 307 illustrating the method depicted in FIG. 3A based on a plurality of image frames according to an embodiment. In this embodiment, a plurality of frames within a time period of 10:01 and 10:06 is retrieved and tabulated in a chronological order in table 308. Based on table 308, a co-appearance of the first target 310a and the second target 310b at 10:05 or in image frame 308d is detected.

Additionally, an appearance of the first target in a frame in which a second target 310b appears and the first target 310a does not appear, such as frame 308b, may be estimated based on the appearance data relating to the first target 310a in at least two frames before and after the frame 308b. In particular, appearance data relating the first target 310a in frames 308a, 308c before and after the frame 308b are retrieved. Subsequently, location information and time information in each of the frames 308a, 308c are identified based on the retrieved appearance data. Next, the appearance of the first target 310a in the frame 308b is estimated based on the identified location information and the time information of the frames 308a, 308c. As such, a co-appearance of the first target 310a and the second target 310b can be detected at 10:02 or in the frame 308b in which the second target 310b appear and the first target 310a does not appear, based on the appearance of the second target 310b and estimated appearance of the first target 310a in the frame 308b. In an embodiment, co-appearance data corresponding to such co-appearance may comprise estimated appearance data relating to the first target 310a and appearance data relating to the second target 310b in the frame 308b. Subsequently, both image frames 308b, 308d in which a co-appearance is detected may be stored in a list (not shown) such that respective co-appearance data 312a, 312b may be retrieved for further analysis.

In various embodiments, co-appearance data may include location information such as image-coordinates of targets, time information such as co-appearance time indicating a time at which the co-appearance is detected, frame information such as allotted frame number of the frame in which the co-appearance is detected, and image information such as an indicator of an imaging condition in which the frame is captured (or detected).

In an embodiment, as shown in process 316, co-appearance data relating to the first target 310a and the second target 310b, like 312a and 312b in the list (not shown) may be retrieved and used for further analysis such as determining a co-appearance frequency of the first target 310a and second target 310b over a period, and an estimated distance between the first and second targets in a frame, such as frames 308b and 308d. Subsequently, in process 318, a co-appearance in-contact confidence score between the first target 310a and second target 310b is determined based, for example, on an in-contact threshold, co-appearance time, the co-appearance frequency and the estimated distance, the co-appearance in-contact confidence score indicating a likelihood on how the first target relates to (or associate with) the second target. More information on processes 316, 318 will be discussed further.

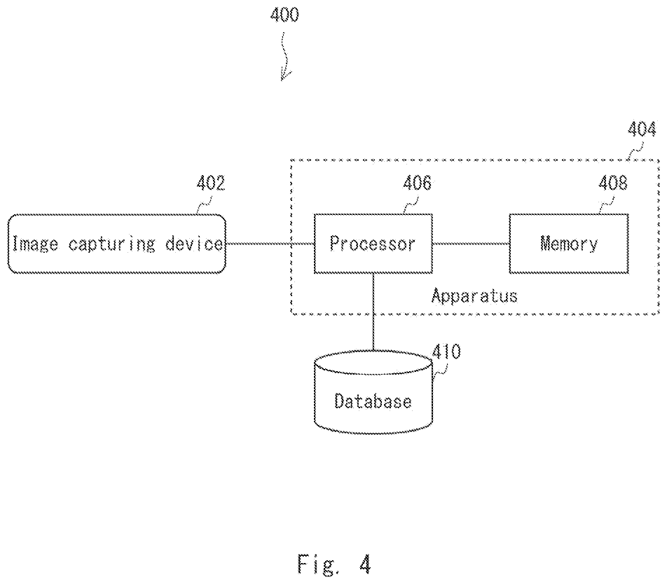

FIG. 4 depicts a block diagram illustrating a system 400 for estimating an appearance of a first target in a frame, the frame being one in which a second target appears and the first target does not appear, according to an embodiment. In an example, the managing of image input is performed by at least an image capturing device 402 and an apparatus 404. The system 400 comprises an image capturing device 402 in communication with the apparatus 404. In an implementation, the apparatus 404 may be generally described as a physical device comprising at least one processor 406 and at least one memory 408 including computer program code. The at least one memory 408 and the computer program code are configured to, with the at least one processor 406, cause the physical device to perform the operations described in FIG. 3. The processor 406 is configured to receive a plurality of image frames from the image capturing device 402 or to retrieve a plurality of image frames from a database 410.

The image capturing device 402 may be a device such as a closed-circuit television (CCTV) which provides a variety of information of which characteristic information and time information that can be used by the system to detect and estimate co-appearances. In an implementation, the characteristic information derived from the image capturing device 402 may include facial information of known or unknown target. For example, facial information of a known target may be that closely linked to a criminal activity which is identified by an investigator and stored in memory 408 of the apparatus 404 or a database 410 accessible by the apparatus 404. Additionally or alternatively, the characteristic information used for target identification may include physical characteristic information such as height, body size, hair colour, skin colour, apparel, belongings, other similar characteristic or combinations, or behavioral characteristic information such as body movement, position of limbs, direction of movement, the way of a target subject walks, stands, moves and talks, other similar characteristic or combination. In an implementation, the time information derived from the image capturing device 402 may include a timestamp at which a target is identified. The time timestamp may be stored in memory 408 of the apparatus 404 or a database 410 accessible by the apparatus 404 to draw a relationship among detected targets in a criminal activity. It should be appreciated that the database 410 may be a part of the apparatus 404.

The apparatus 404 may be configured to communicate with the image capturing device 402 and the database 410. In an example, the apparatus 404 may receive, from the image capturing device 402, or retrieve from the database 410, a plurality of image frames relating to a same field of view of a location as input, and after processing by the processor 406 in apparatus 404, generate an output which may be used to estimate an appearance of a first target in a frame, the frame being one in which a second target appears and the first target does not appear.

According to the present disclosure, after receiving an image from the image capturing device 402, or retrieve an image from the database 410, the memory 408 and the computer program code stored therein are configured to, with the processor 406 cause the apparatus 404 to retrieve appearance data relating to the first target in at least two frames before and after the frame within a threshold period, the at least two frames being those in which the first target appears; identify location information and time information of the first target in the at least two frames based on the retrieved appearance data; and estimating the appearance of the first target in the frame based on the identified location information and the time information. The appearance data may be retrieved from the image capturing device 402 or the databased 410 accessible by the apparatus 404.

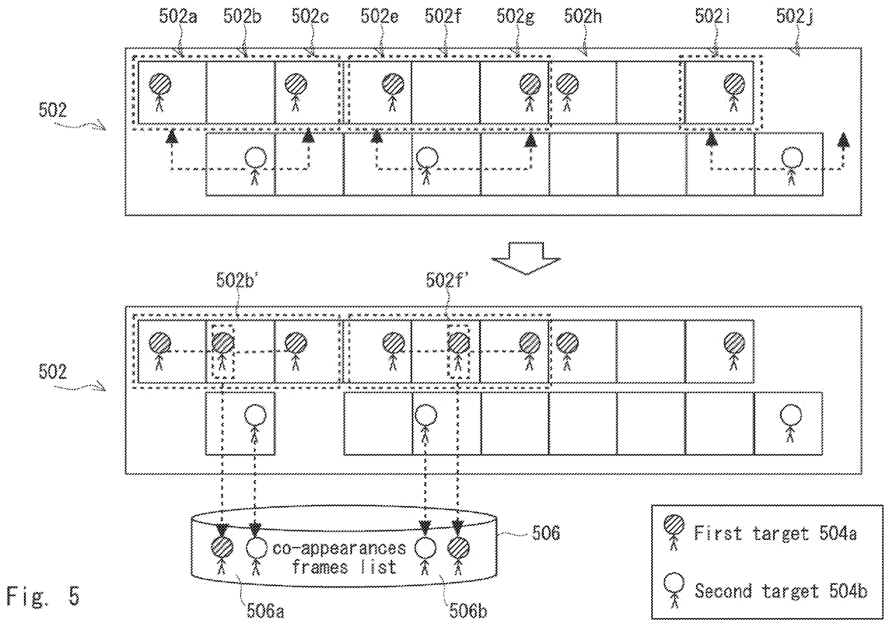

FIG. 5 depicts a flow diagram 500 illustrating a method for estimating an appearance of a first target in a frame based on a plurality of image frames according to an embodiment. In this embodiment, a plurality of frames captured at a camera within a time period, in which appearances of a first target 504a and a second target 504b are detected, is retrieved and tabulated in a chronological order in table 502 to detect co-appearances of the first target 504a and the second target 504b. In particular, it is detected that the first target 504a appears in image frames 502a, 502c, 502e, 502g, 502h and 502i, whereas the second target 504b appears in image frames 502b, 502f and 502j. Specifically, in an image frame where an appearance of the second target 504b is detected but an appearance of the first target 504a is not detected or is missing (hereinafter referred to as “intended frame”) such as image frames 502b, 502f, 502j, appearance data of the first target 504a in the intended frame may be estimated based on at least two image frames before and after the intended frame within a threshold period, the at least two image frames being those in which the first target appears (hereinafter referred to as “neighbouring frame”).

For example, as shown in FIG. 5, appearance of the first target 504a in an intended frame 502b may be estimated based on two neighbouring frames 502a, 502b. As such, appearance data relating to the first target 504a in the two neighbouring image 502a, 502b may be retrieved, and location information and the time information of the first target 504a in the two neighbouring image frames may be then identified and used for estimating the appearance of the first target 504a in the intended frame 502b. Similarly, appearance of the first target 504a in another intended frame 502f may be estimated based on two neighbouring frames 502e, 502g.

In various embodiments, a threshold period may be configured such that the at least two neighbouring image frames fall within the threshold period, where a threshold period can be implemented as a time period before and after a time instance at which the intended frame is captured (or detected), or a number of frames before and after the intended frame. In one example, for estimating an appearance of the first target 504a in the intended frame 502f with a threshold period configured as 3 image frames, indicating that the neighbouring frames should be no more than 3 image frames before or after the intended frame 502f, the neighbouring frames can be image frames 502c, 502e, 502g and/or 502h. The image frames 502a, 502i, which are 4 image frames before and after the intended frame respectively, do not fall within the threshold period, hence they will not be retrieved as neighbouring frames and used for estimating an appearance of the first target in intended frame 502f. In another examples, the threshold period can be configured as 3 seconds, as such any frames that is captured within 3 seconds before and after the intended frame will be regarded as neighbouring frames for estimating an appearance of the first target 504a in the intended frame.

According to the present disclosure, the appearance of the first target in an intended frame is estimated based on appearance data relating to the first target in neighbouring frames, in particular, the location information and the time information relating to the first target in the neighbouring frames. Specifically, the location information of the first target in the neighbouring image frames may be identified through receiving parameters relating the camera (e.g. number of pixels and focal length) and calculating image co-ordinates of the first target in the neighbouring frames based on the received parameters. In an embodiment, the location information and the time information of the neighbouring frames may be further processed, for example, by calculating average image co-ordinates from the image co-ordinates of the first target in the neighbouring frames, and the appearance data relating to the estimated appearance of the first target in the intended frame may be obtained based on the processed location information and time information.

Returning to FIG. 5, subsequent to estimating appearances of the first target, the first target 504a can then be detected as appearing in the intended image 502b′, 502f′ based on the estimated appearances. Accordingly, a co-appearance of the first target and the second target can be detected in the intended frames 502b′, 502f based on the appearance of the second target 504b and the estimated appearance of the first target 504a in the intended frame 502b′, 502f. Subsequently, each image frame in which a co-appearance of the first target 504a and the second target 504b is detected may be stored in a list, e.g. co-appearance frame list 506, such that respective co-appearance data like 506a, 506b relating to the first target 504a and the second target 504b in the image frame may be retrieved for further analysis.

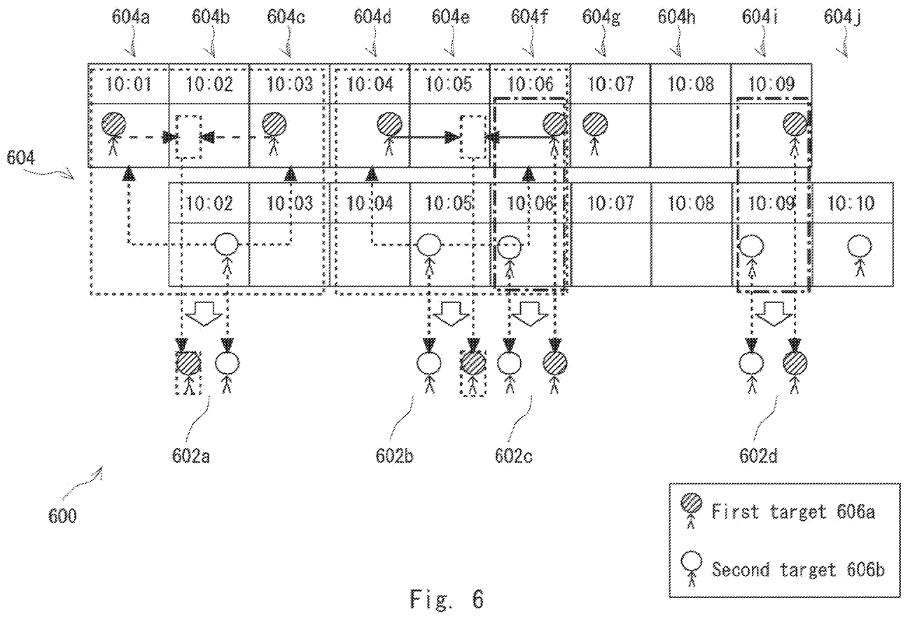

FIG. 6 depicts a flow diagram 600 illustrating a process for identifying co-appearance of two targets according to an embodiment. In this embodiment, processes for estimating an appearance of a first target in an intended frame, i.e. an image frame where a second target appears and the first target does not appear, are applied to a plurality of images 604a to 604j in table 604 of FIG. 6. In particular, in table 604, it is detected that a first target 606a appears in image frames 604a, 604c, 604d, 604f, 604g, 604i whereas a second target 606b appears in image frames 604b, 604e, 604f, 604i and 604j. Based on table 604, it can be identified that both the first target 606a and the second target 606b appear in image frame 604f and image frame 604i. Correspondingly, two co-appearances of the first target 606a and the second target 606b in image frames 604f, 604i are detected, The respective co-appearance data relating to the first target 606a and the second target 606b in image frames 604f, 604i shown in 602c and 602d may then be stored in a list (not shown) for further analysis.

Further, an intended frame, i.e. an image frame a second target appears and the first target does not appear, such as image frame 604b, 604e, is identified. An appearance of the first target 216a in the intended frame is estimated based on appearances of the first target 606a in at least two neighbouring image frames, i.e. image frames before and after the intended frame, the image frames being those in which the first target appears. In particular, an appearance of the first target 606a in the intended frame 604b is estimated based on appearances of the first target in image frames 604a and 604c; whereas an appearance of the first target 606a in the intended frame 604e is estimated based on appearance of the first target in image frames 604d and 604f. Subsequently, two co-appearances of the first target 216a and the second target 216b in the intended frames 604b and 604e can also be detected. The respective co-appearance data relating to the first target 606a and the second target 606b in image frames 604b and 604e shown in 602a and 602b may then be stored in a list (not shown) for further analysis.

It is noted that in the convention process illustrated in FIG. 2B, only two co-appearances of the first target 216a and the second target 216b may be detected; whereas in the process of the present disclosure, four co-appearances of the first target 606a and the second target 606b can be detected, including the two co-appearances of the first target 606a and the second target 606b in image frames 604f, 604i detected via the convention process and the two co-appearance 602a and 602b detected via process of the present disclosure, and used for further analysis such as determining an estimated distance between the first and second targets in a frame and calculating a co-appearance in-contact confidence score indicating a potential association or a likelihood on how the first target relates to (or associate with) the second target as shown in processes 316 and 318 respectively. Advantageously, the processes of the present disclosure may provide a more accurate analysis result in calculating a co-appearance frequency and a potential association between two targets.

In the following paragraphs, certain exemplifying embodiments are explained with reference to apparatus and method for calculating an estimated distance between two targets in an image frame and calculating a co-appearance in contact confidence score of the two targets based on co-appearance data.

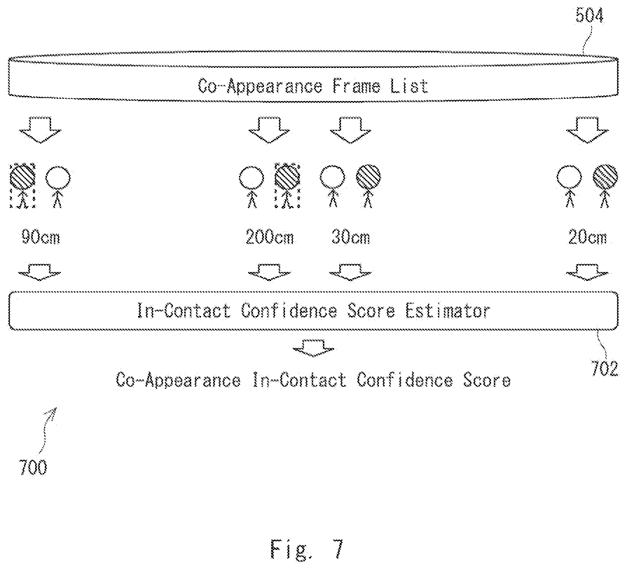

According to the present disclosure, co-appearance data relating to two targets within a time period are retrieved, and a co-appearance in-contact confidence score is calculated based on estimated distances determined from the retrieved co-appearance data. FIG. 7 depicts a flow diagram 700 illustrating a process for determining a co-appearance in-contact confidence score based on estimated distances between two targets according to an embodiment. In this embodiment, four co-appearances of two targets may be detected within a time period. Co-appearance data corresponding to the four co-appearances of the two targets within a time period may be retrieved from a co-appearance frame list 504. An estimated distance between the two targets is determined for each retrieved co-appearance. In particular, four estimated distances of 90 cm, 200 cm, 30 cm and 20 cm are calculated from the four retrieved co-appearance data relating to two targets respectively. Subsequently, the calculated estimated distances may be sent to an in-contact confidence score estimator 702 to calculate a co-appearance in-contact confidence score.

An example calculation of in-contact confidence score is demonstrated in table 1 and equation 1. In this example calculation, each estimated distance is used to calculate a distance score x by deducting the estimated distance with an in-contact distance threshold x0, in this case x0 is 73 cm. In this embodiment, the in-contact distance threshold of 73 cm is set based on an arm reaching distance of a target with a height of 1.7 m. For example, for an estimated distance of 20 cm, the distance score x is calculated as −53; whereas for an estimated distance of 200 cm, the distance score x is calculated as 127. Each distance score is then normalized. In particular, for a distance score that is smaller than 0, i.e. negative score, the distance score is normalized to 0 (when x−x0<0, y=0); for a distance score that is larger than 100, the distance score is normalized to 100 (when x−x0>100, y=100); otherwise, the distance score is taken as the normalize distance score (when 0 ? x−x0? 100, y=x−x0). Correspondingly, a normalized distance score y is obtained for each retrieved co-appearance of the two targets.

TABLE 1
An example calculation of normalization distance score based
on estimated distance between two targets, where x0 is an
in-contact distance threshold and in this example x0 is 73.

| | Estimated | | Normalize distance score y |
|---|---|---|---|
| | distance x | Distance score x − x₀ | where x − x₀ < 0, y = 0 |
| # | (cm) | where x₀ = 73 | where x − x₀ > 100, y = 100 |
| 1 | 20 | 20 − 73 = −53 | 0 |
| 2 | 30 | 30 − 73 = −43 | 0 |
| 3 | 90 | 90 − 73 = 17 | 17 |
| 4 | 200 | 200 − 73 = 127 | 100 |

$$In - Contact Confidence Score = 100 - \frac{Sum of normalize distance score}{Total number of co - appearances} \qquad ( Equation 1 )$$

Subsequently, in-contact confidence score of the two targets can be calculated based on the normalize distance scores and equation 1. Based on equation 1, it is calculated that the in-contact confidence score of the two targets is (100−((0+0+17+100))?4) or 70.75. In various embodiments of the present disclosure, a higher in-contact confidence score refers to a greater likelihood of how the two targets relates to (or associate with) each other.

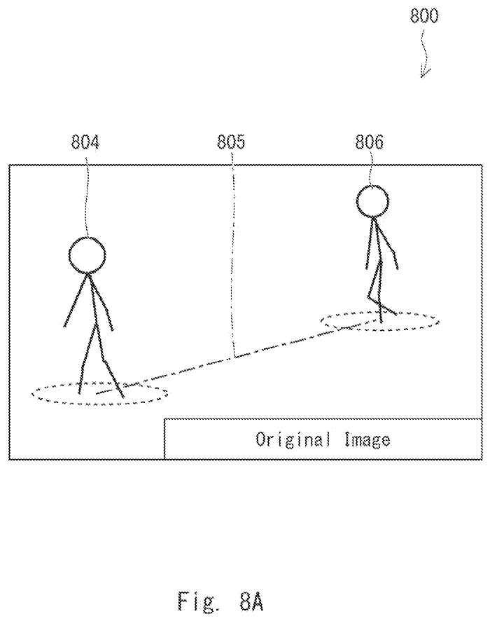

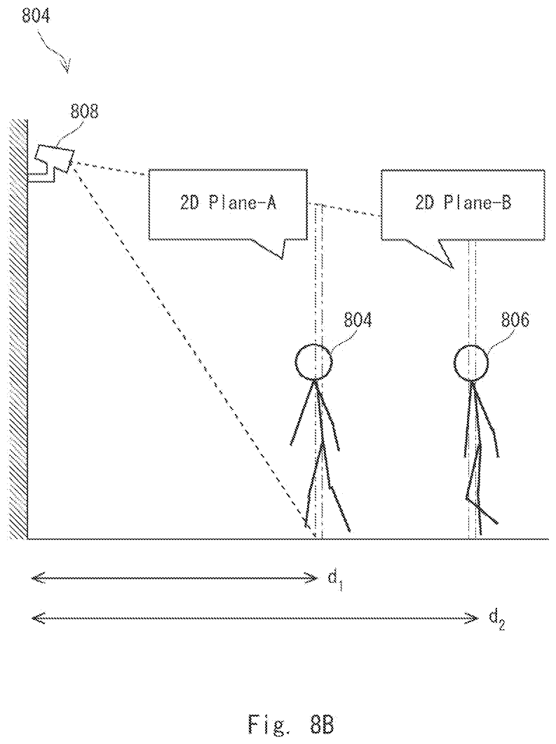

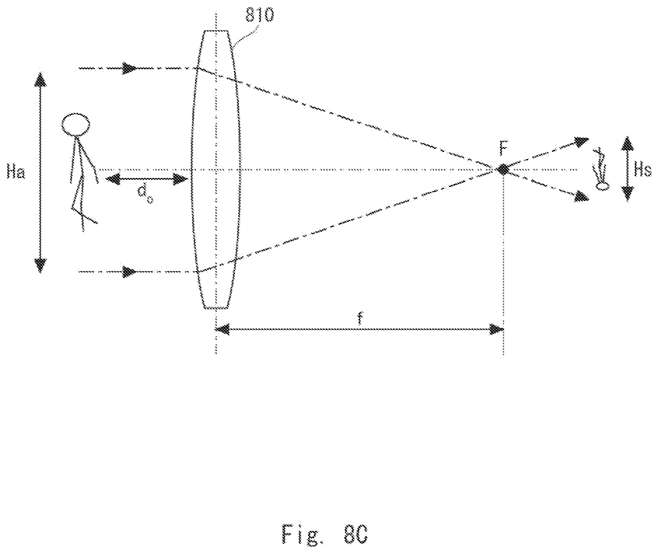

FIGS. 8A to 8C show a process of how an estimated distance of two targets is determined from an image frame 802 according to an embodiment. In particular, FIG. 8A depicts an image frame 802 comprising a co-appearance of a first target 804 and a second target 806 detected by an image capturing device. In an embodiment, the appearance of one of the first target 804 and the second target 806 may be one estimated based the appearance of the target in at least two image frames before or after the image frame 802 according to the method of FIG. 3A. In various embodiments, an estimated distance between two targets are calculated based on a distance between bottom center of each of the targets where the legs of the targets are positioned, as illustrated using a dashed line 805 in FIG. 8A.

Further, parameters of the image capturing device such as resolution or number of pixels in the image frame 802 can be used for estimating a distance between targets. In particular, a number of pixels occupied by a target in a vertical direction in the image frame can be used to calculate a length unit corresponding to a single pixel. For example, the image capturing device may capture the image frame 802 in a total of 720 pixels in a vertical direction. Such parameters regarding the total number of pixels in the vertical direction of the image frame may be retrieved. Based on the parameter of the image capturing device and characteristic information of the first target 804, for example height of 1.7 m, either known or detected from the image frame 802, if a number of 100 pixels is used in displaying the first target 804 in the image frame 802 in the vertical direction, a length unit of 1.7 cm/pixel of the image frame can be determined and use for further determination of the estimated distance 805 between the first target 804 and the second target 806. In an embodiment, the characteristic information of the first target is assumed based on average characteristic information of a plurality of detected targets or a population, and the assumed characteristic information is used for determining the estimated distance 805.

FIG. 8B is an explanatory diagram showing respective perpendicular distances of two targets from the image capturing device when the image frame 802 is captured. It is noted that the image capturing device is fixed in position having a field of view of a location. In general, if both targets have a similar height, a target who appears larger in an image frame indicates that the target is positioned closer to the image capturing device, whereas a target who appears smaller in an image frame indicates that the target is positioned further to the image capturing device. In other words, based on characteristic information of both targets 804, 806 where both targets 804, 806 have a similar height, as the first target 804 takes a larger image area than the second target 806, this corresponds to a shorter perpendicular distance from the image capturing device 808 to the first target 804 then to the second target 806 (d₁<d₂), at 2D Plane-A and 2D Plane-B respectively, as illustrated in FIG. 8B.

FIG. 8C shows an explanatory diagram on a relationship among a physical height Hₐ of a target, a dimension Hₛ in an image frame, a focal length of the image capturing device f and a distance of the target from the image capturing device dₒ. A dimension Hₛ in an image frame may be interpreted as a number of pixels that are used to display in a particular direction in an image frame. Specifically, a target with a height Hₐ is detected by an image capturing device at a distance dₒ from the image capturing device through focal lens 812 and appears in a dimension of Hₛ in an image frame. Based on characteristic information of the target such as the target's height Hₐ and parameters of the image capturing device such as its focal length and number of pixels in displaying the dimension Hₛ the distance dₒ can be calculated using equation 2. In this way, the distances d₁, d₂ of targets 804, 806 from the image capturing device 808 can be calculated and used for further determination of the estimated distance 805 between the first target 804 and the second target 806.

$${d}_{o} = \frac{{H}_{a} \times f}{{H}_{s}} \qquad ( Equation 2 )$$

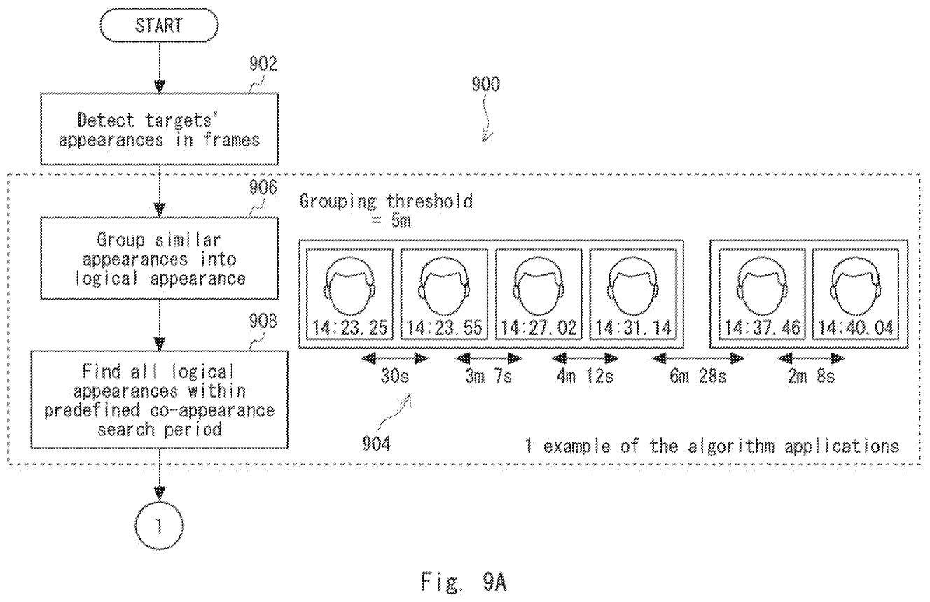

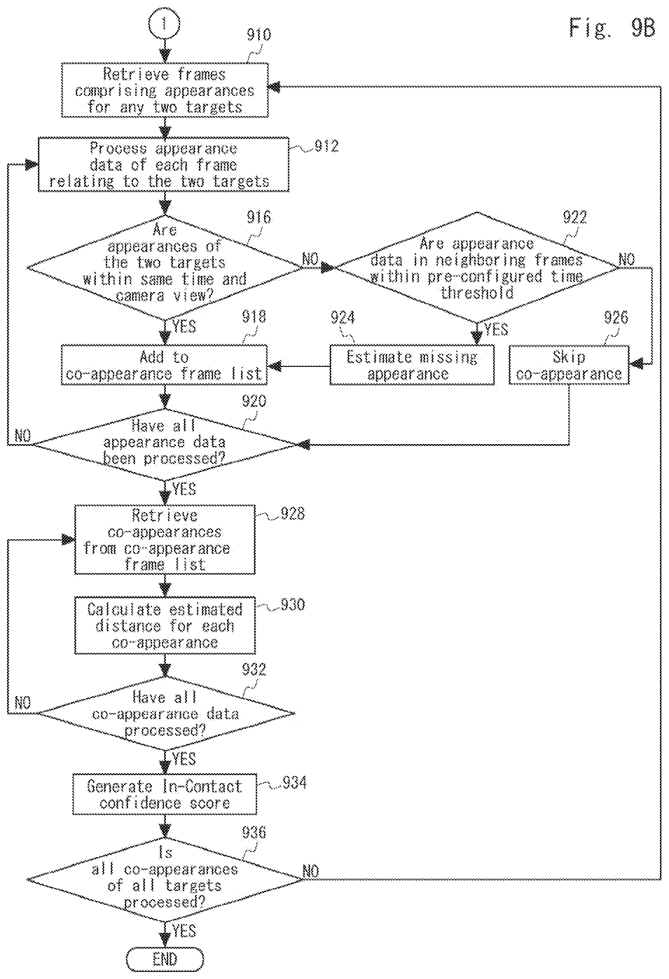

FIGS. 9A and 9B depict a flow chart 900 illustrating a process of estimating an appearance of a first target in a frame according to an embodiment. In step 902, a plurality of image frames may be captured by an image capturing device to detect targets' appearances in the plurality of image frames. In step 906, similar appearances of a target may be grouped together and the frames in which the target appears may be tabulated according to time information and location information, such as table 904. The tabulated frames may be further group according to logical appearance. In an embodiment, a threshold such as a grouping threshold or a logical appearance interval threshold is used for grouping consecutive appearances of a target into a logical appearance. For example in this case where a grouping threshold is set to be 5 minutes, any two consecutive appearances of a target having an interval within 5 minutes are grouped as a logical appearance; whereas two consecutive appearances of the target having an interval exceeds 5 minutes are detected as two separate logical appearances of the target respectively, as shown in table 904. In step 908, the process may be set to find logical appearances of every target detected within a pre-defined co-appearance search period. It is noted that steps 906 and 908 are one example of the algorithm applications. There are many other algorithm applications in processing appearances detected in step 902.

In step 910, all frames comprising appearances of any two targets within the pre-defined co-appearance search period are retrieved. In step 912, all appearance data of each retrieved frame relating to the two targets are then processed. In step 916, based on the data, it is determined if appearances of the two targets are detected at a same time and under a same camera view. If it is determined that the two targets does not appear at a same time and camera view, for example, if there is a missing appearance of a first target in a target image frame in which a second target appear and the first target does not, step 922 is carried out. In step 922, it is determined if appearance data relating to the first target, who does not appear in the target image frame, can be found in neighbouring frames before and after the target image frame within a pre-configured time threshold. If appearance data are found in neighbouring frames within the pre-configured time threshold, step 924 is carried out; otherwise step 926 is carried out. In step 924, the missing appearance data relating to the first target in the target image frame is estimated based on the neighbouring frames and then the process is directed to step 918. On the other hand, if appearance data in neighbouring frames within the pre-configured time threshold could not be found, co-appearance of the two targets in the intended frame may not be detected and the process may be directed to step 920.

Returning to step 916, if it is determined that the two targets appears at a same time and camera view, for example, the two targets appears in an image frame, a co-appearance of the two targets is detected, and step 918 is then carried out. In step 918, the image frame in which the co-appearance of the targets is detected is added into a co-appearance frame list. In step 920, it is then determined if all appearance data of each frame relating to the two targets have been processed. If not so, the process may be directed to step 912 to process any remaining appearance data relating to the two targets. If all appearance data of each frame relating to the two targets have been processed, step 928 is carried out.

In step 928, all frames relating to a co-appearance of the two targets are retrieved from the co-appearance frame list. In step 930, an estimated distance is calculated for each co-appearance based on co-appearance data relating to the two targets. In step 932, it is determined if all co-appearance data relating to the two targets from the co-appearance frame list have been processed. If not so, the process may be directed back to step 928 to process any remaining co-appearances in the co-appearance frame list. If all co-appearance data have been processed, step 934 is carried out. In step 934, an in-contact confidence score for the two targets is calculated based on the estimated distances calculated in step 930. Subsequently, in step 936, it is determined if all appearance data relating to every target detected within a pre-defined co-appearance search period has been processed. In not so, the process may be directed back to step 910 to retrieve all frames comprising appearances of other two targets within the pre-defined co-appearance search period. If it is determined that all appearance data relating to every target detected within a pre-defined co-appearance search period has been processed, the process may end.

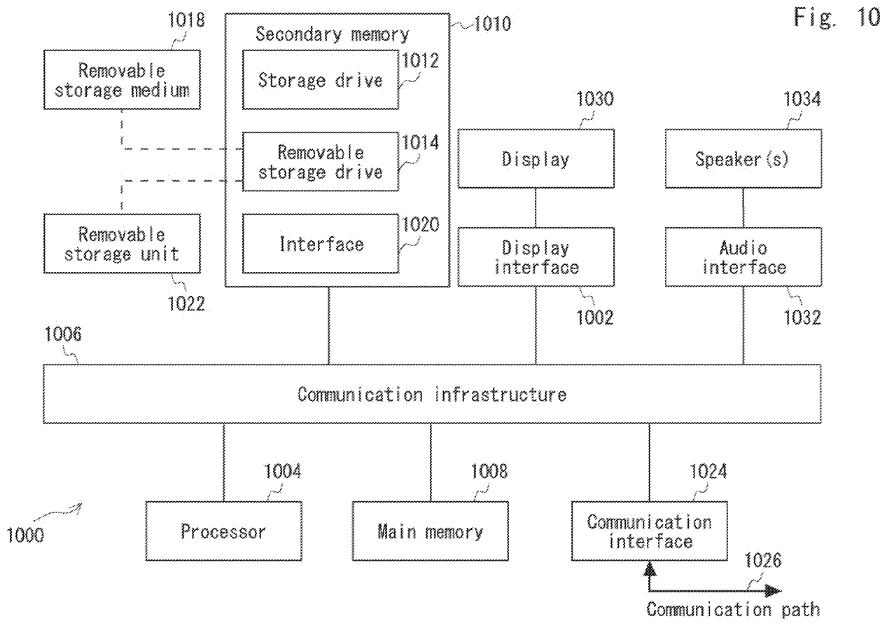

FIG. 10 depicts an exemplary computing device 1000, hereinafter interchangeably referred to as a computer system 1000, where one or more such computing devices 1000 may be used to execute the method of FIG. 3A. The exemplary computing device 1000 can be used to implement the system 400 shown in FIG. 4. The following description of the computing device 1000 is provided by way of example only and is not intended to be limiting.

As shown in FIG. 10, the example computing device 1000 includes a processor 1004 for executing software routines. Although a single processor is shown for the sake of clarity, the computing device 1000 may also include a multi-processor system. The processor 1004 is connected to a communication infrastructure 1006 for communication with other components of the computing device 1000. The communication infrastructure 1006 may include, for example, a communications bus, cross-bar, or network.

The computing device 1000 further includes a main memory 1008, such as a random access memory (RAM), and a secondary memory 1010. The secondary memory 1010 may include, for example, a storage drive 1012, which may be a hard disk drive, a solid state drive or a hybrid drive and/or a removable storage drive 1014, which may include a magnetic tape drive, an optical disk drive, a solid state storage drive (such as a USB flash drive, a flash memory device, a solid state drive or a memory card), or the like. The removable storage drive 1014 reads from and/or writes to a removable storage medium 1018 in a well-known order. The removable storage medium 1018 may include magnetic tape, optical disk, non-volatile memory storage medium, or the like, which is read by and written to by removable storage drive 1014. As will be appreciated by persons skilled in the relevant art(s), the removable storage medium 1018 includes a computer readable storage medium having stored therein computer executable program code instructions and/or data.

In an alternative implementation, the secondary memory 1010 may additionally or alternatively include other similar means for allowing computer programs or other instructions to be loaded into the computing device 1000. Such means can include, for example, a removable storage unit 1022 and an interface 1020. Examples of a removable storage unit 1022 and interface 1020 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 1022 and interfaces 1020 which allow software and data to be transferred from the removable storage unit 1022 to the computer system 1000.

The computing device 1000 also includes at least one communication interface 1024. The communication interface 1024 allows software and data to be transferred between computing device 1000 and external devices via a communication path 1024. In various embodiments of the inventions, the communication interface 1024 permits data to be transferred between the computing device 1000 and a data communication network, such as a public data or private data communication network. The communication interface 1024 may be used to exchange data between different computing devices 1000 which such computing devices 1000 form part an interconnected computer network. Examples of a communication interface 1024 can include a modem, a network interface (such as an Ethernet card), a communication port (such as a serial, parallel, printer, GPIB, IEEE 1394, RJ45, USB), an antenna with associated circuitry and the like. The communication interface 1024 may be wired or may be wireless. Software and data transferred via the communication interface 1024 are in the form of signals which can be electronic, electromagnetic, optical or other signals capable of being received by communication interface 1024. These signals are provided to the communication interface via the communication path 1024.

As shown in FIG. 10, the computing device 1000 further includes a display interface 1002 which performs operations for rendering images to an associated display 1030 and an audio interface 1032 for performing operations for playing audio content via associated speaker(s) 1034.

As used herein, the term “computer program product” may refer, in part, to removable storage medium 1018, removable storage unit 1022, a hard disk installed in storage drive 1012, or a carrier wave carrying software over communication path 1026 (wireless link or cable) to communication interface 1024. Computer readable storage media refers to any non-transitory, non-volatile tangible storage medium that provides recorded instructions and/or data to the computing device 1000 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 1000. Examples of transitory or non-tangible computer readable transmission media that may also participate in the provision of software, application programs, instructions and/or data to the computing device 1000 include radio or infra-red transmission channels as well as a network connection to another computer or networked device, and the Internet or Intranets including e-mail transmissions and information recorded on Websites and the like.

The computer programs (also called computer program code) are stored in main memory 1008 and/or secondary memory 1010. Computer programs can also be received via the communication interface 1024. Such computer programs, when executed, enable the computing device 1000 to perform one or more features of embodiments discussed herein. In various embodiments, the computer programs, when executed, enable the processor 1004 to perform features of the above-described embodiments. Accordingly, such computer programs represent controllers of the computer system 1000.

Software may be stored in a computer program product and loaded into the computing device 1000 using the removable storage drive 1014, the storage drive 1012, or the interface 1020. The computer program product may be a non-transitory computer readable medium. Alternatively, the computer program product may be downloaded to the computer system 1000 over the communications path 1027. The software, when executed by the processor 1004, causes the computing device 1000 to perform the necessary operations to execute the method as shown in FIG. 3A.

It is to be understood that the embodiment of FIG. 10 is presented merely by way of example to explain the operation and structure of the system 400. Therefore, in some embodiments one or more features of the computing device 1000 may be omitted. Also, in some embodiments, one or more features of the computing device 1000 may be combined together. Additionally, in some embodiments, one or more features of the computing device 1000 may be split into one or more component parts.

It will be appreciated that the elements illustrated in FIG. 10 function to provide means for performing the various functions and operations of the servers as described in the above embodiments.

When the computing device 1000 is configured to optimize efficiency of a transport provider, the computing system 1000 will have a non-transitory computer readable medium having stored thereon an application which when executed causes the computing system 1000 To perform steps comprising: receive a first departure time of a vehicle which is administered by the transport provider at a first location; receive a second departure time of the vehicle at a second location which is located after the first location; determine a difference between the first departure time and the second departure time; and update a current schedule to provide an updated schedule in response to the determination of the difference, the updated schedule indicating an updated estimated arrival time of the vehicle at a location after the second location.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

Although the present invention has been described with reference to the exemplary embodiments, the present invention is not limited to the above. Various changes that can be understood by those skilled in the art can be made to the configuration and details of the present invention within the scope of the invention.

This application is based upon and claims the benefit of priority from Singapore provisional patent application No. 10202002677T, filed on Mar. 23, 2020, the disclosure of which is incorporated herein in its entirety by reference.

### REFERENCE SIGNS LIST

400 system
402 image capturing device
404 apparatus
406 processor
408 memory
410 database

What is claimed is:

1. A method for estimating an appearance of a first target in a frame, the frame being one in which a second target appears and the first target does not appear, comprising:
retrieving appearance data relating to the first target in at least two frames before and after the frame within a threshold period, the at least two frames being those in which the first target appears;
identifying location information and time information of the first target in the at least two frames based on the retrieved appearance data; and
estimating the appearance of the first target in the frame based on the identified location information and the time information.

2. The method according to claim 1, wherein the step of identifying the location information of the first target in the at least two frames comprises:
receiving parameters relating to an image capturing device used to capture the at least two frames relating to the appearance of the first target; and
calculating image co-ordinates of the first target in the at least two frames based on the received parameters,
wherein the appearance of the first target is estimated based on the calculated image coordinates of the first target in the at least two frames.

3. The method according to claim 1, further comprising:
including co-appearance data relating to the first target and the second target in the frame into a list, the co-appearance data comprising appearance data corresponding to the estimated appearance of the first target in the frame and appearance data relating to the second target in the frame.

4. The method according to claim 1, further comprising:
identifying location information of each of the first target and the second target in the frame; and
estimating a distance between the first target and the second target based on the location information and characteristic information of each of the first target and the second target.

5. The method according to claim 4, further comprising:
determining if the estimated distance falls below a distance threshold, wherein the estimated distance falling below the distance threshold indicating a distance in which the first target is determined to be in contact with the second target, and
calculating a likelihood of how the first target relates to the second target based on the estimated distance.

6. The method according to claim 1, wherein the step of retrieving appearance data relating to the first target in at least two frames before and after the frame within a threshold period comprises:
tabulating frames relating to the first target and the second target based on each corresponding location and time information.

7. The method according to claim 1, further comprising:
receiving an input, the input being a plurality of frames relating to a same field of view of a location captured by an image capturing device, wherein the detection of the appearances of the first target and the second target is based on the received input.

8. An apparatus for estimating an appearance of a first target in a frame, the frame being one in which a second target appears and the first target does not appear, comprising:
a memory in communication with a processor, the memory storing a computer program recorded therein, the computer program being executable by the processor to cause the apparatus at least to:
retrieve appearance data relating to the first target in at least two frames before and after the frame within a threshold period, the at least two frames being those in which the first target appears;
identify location information and time information of the first target in the at least two frames based on the retrieved appearance data; and
estimate the appearance of the first target in the frame based on the identified location information and the time information.

9. The apparatus according to claim 8, wherein the memory and the computer program are executed by the processor to cause the apparatus further to:
receive parameters relating to an image capturing device used to capture the at least two frames relating to the appearance of the first target; and
calculate image co-ordinates of the first target in the at least two frames based on the received parameters,
wherein the appearance of the first target is estimated based on the calculated image coordinates of the first target in the at least two frames.

10. The apparatus according to claim 8, wherein the memory and the computer program are executed by the processor to cause the apparatus further to:
include co-appearance data relating to the first target and the second target in the frame into a list, the co-appearance data comprising appearance data corresponding to the estimated appearance of the first target in the frame and appearance data relating to the second target in the frame.

11. The apparatus according to claim 8, wherein the memory and the computer program are executed by the processor to cause the apparatus further to:
identify location information of each of the first target and the second target in the frame; and
estimate a distance between the first target and the second target based on the location information and characteristic information of each of the first target and the second target.

12. The apparatus according to claim 11, wherein the memory and the computer program are executed by the processor to cause the apparatus further to:
determine if the estimated distance falls below a distance threshold, wherein the estimated distance falling below the distance threshold indicating a distance in which the first target is determined to be in contact with the second target; and
calculate a likelihood of how the first target relates to the second target based on the estimated distance.

13. The apparatus according to claim 8, wherein the memory and the computer program are executed by the processor to cause the apparatus further to:
tabulate frames relating to the first target and the second target based on each corresponding location and time information

14. The apparatus according to claim 8, wherein the memory and the computer program are executed by the processor to cause the apparatus further to:
receive an input, the input being a plurality of frames relating to a same field of view of a location captured by an image capturing device, wherein the detection of the appearances of the first target and the second target is based on the received input.

15. A system for estimating an appearance of a first target in a frame, the frame being one in which a second target appears and the first target does not appear, comprising:
the apparatus as claimed in claim 8 and an image capturing device.
